(19) United States
(12) Patent Application Publication
(10) Pub. No.: US 2015/0160256 A1
(43) Pub. Date: Jun. 11, 2015

(54) MOTION MEASUREMENT SYSTEMS AND METHODS FOR USE IN RODEO COMPETITIONS AND RELATED ACTIVITIES

(71) Applicants: Howard Ross Gwynn, III, Yuma, AZ (US); Howard Thomas Gwynn, Yuma, AZ (US)

(72) Inventors: Howard Ross Gwynn, III, Yuma, AZ (US); Howard Thomas Gwynn, Yuma, AZ (US)

(21) Appl. No.: 14/567,628

(22) Filed: Dec. 11, 2014

Related U.S. Application Data
(60) Provisional application No. 61/914,580, filed on Dec. 11, 2013.

(51) Int. Cl. G01P 13/00; A63B 71/06; A01K 29/00

(52) U.S. Cl. CPC G01P 13/00; A01K 29/00; A63B 71/06

(57) ABSTRACT

A motion measurement system for measuring changes in the motion of the body of an animal. An animal instrumentation assembly of the motion measurement system has a plurality of motion measurement sensors that are operatively coupled to a selected portion of the body of an animal. The motion measurement sensors produce measurement signals indicative of the change in the motion of the animal, and these measurement signals are transmitted to a processor of the animal instrumentation assembly. A wireless transmitter transmits wireless signals corresponding to the measurement signals, and these wireless signals are received by a computing assembly. A processor of the computing assembly converts the wireless signals into corresponding animal data elements, which are stored in a memory. The computing assembly can be positioned in wireless communication with remote computing devices to permit distribution of the animal data elements.

### CROSS-REFERENCE TO RELATED PATIENT APPLICATION

This application claims priority to U.S. Provisional Patent Application No. 61/914,580, filed Dec. 11, 2013, which is incorporated by reference herein in its entirety.

### FIELD

This invention relates to a motion measurement system for measuring changes in the motion of an animal. This invention further relates to a rodeo flag for selectively transmitting instructions to a rodeo event clock.

### BACKGROUND

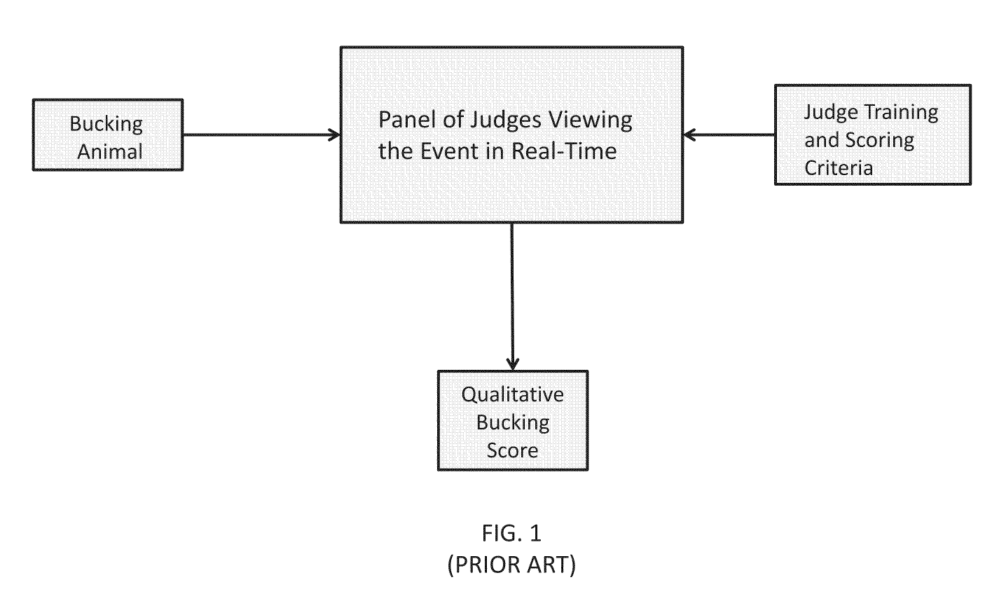

Traditionally, bull riding competitions, bareback bronco riding competitions, and saddle bronco riding competitions have employed a subjective rating system (usually a panel of judges with scoring criteria) to evaluate the performance of a particular bull or bronco. Judges typically look for drops in the front end of the animal, kicks in the back end of the animal, spin of the animal, and directional changes (forward, backward, or side-to-side) of the animal to assess the degree of difficulty encountered by the cowboy or cowgirl while riding the animal. The conventional process for evaluating the performance of a bull or bronco is depicted in FIG. 1.

Additionally, since the beginning of organized rodeo competitions, a person mounted on a horse (referred to as a “rodeo flagger”) has been positioned within the rodeo arena to serve as the referee during a particular rodeo event, such as, for example, bull riding, team roping, calf roping, steer wrestling (bulldogging), team penning, and barrel racing events. The rodeo flagger moves a flag in a certain movement pattern to signal when a rodeo event clock should be stopped or to signal when certain penalties should be applied. A person positioned outside the rodeo arena (referred to as the “time keeper”) watches the signals of the rodeo flagger and manually stops the rodeo event clock when he or she sees the appropriate signals of the rodeo flagger. The delay between the occurrence of the rodeo nagger's signals and the actual stopping of the clock by the time keeper can result in significant errors in the tunes assigned to rodeo event participants.

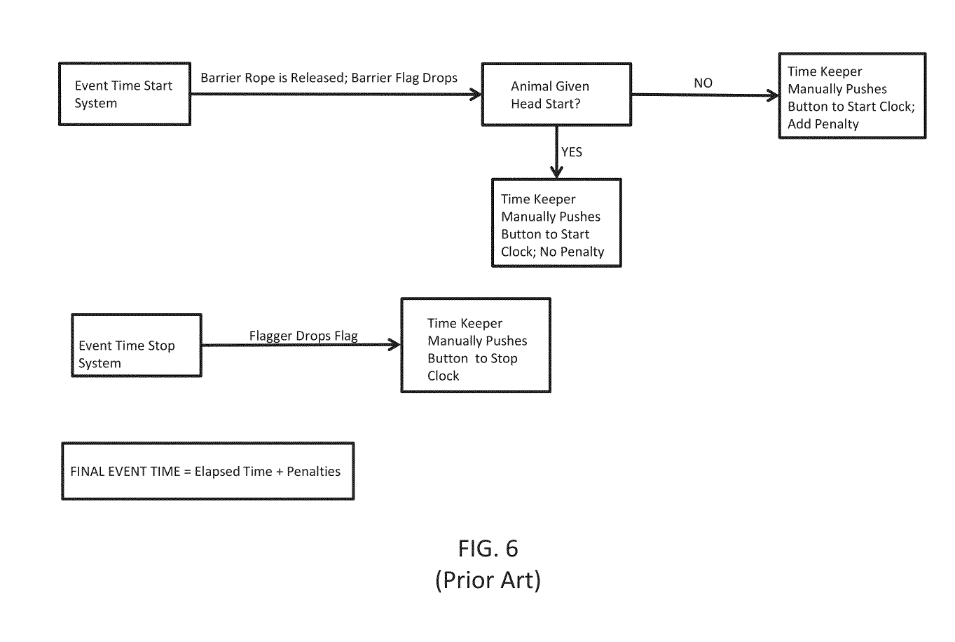

Further, in some rodeo competitions, a flag (referred to as a “barrier flag”) is mounted on a rope (referred to as a “barrier rope”) in front of the horse's starting box and is used to signal the time keeper to manually start the rodeo event clock when either the horses breaks through the barrier rope or the animal reaches its designated head start and the barrier rope is released by a mechanical mechanism. The time keeper, which is positioned outside the arena watches for the barrier rope to be released (or broken through) and the flag to drop, which signals the time keeper to manually start the rodeo event clock. The delay between the occurrence of the flag dropping and the actual starting of the clock by the time keeper can result in significant errors in the times assigned to rodeo event participants. A conventional method of timing rodeo events is depicted in FIG. 6.

Given the increased value of prizes and the larger number of participants in rodeo events, the subjective evaluation of animals and the random timing errors described above can significantly impact the results of important high-stakes rodeo events. Thus, there is a need in the pertinent art for systems that quantitatively assess the performance of animals during rodeo events. There is also a need in the pertinent art for systems and methods that reduce or eliminate the random timing errors associated with the results of timed rodeo events.

### SUMMARY

Described herein, in one aspect, is a motion measurement system for measuring changes in the motion of the body of an animal. The motion measurement system has an animal instrumentation assembly and a computing assembly. The animal instrumentation assembly has a plurality of motion measurement sensors, a processor positioned in operative communication with the plurality of motion measurement sensors, and a wireless transmitter positioned in operative communication with the processor. Each motion measurement sensor is configured for operative coupling to a selected portion of the body of the animal and is further configured to produce a measurement signal indicative of the change in the motion of the animal. The processor is configured to receive the measurement signal from each motion measurement sensor, and the wireless transmitter is configured to selectively transmit at least one wireless signal corresponding to at least one measurement signal produced by the plurality of motion measurement sensors. The computing assembly has a wireless receiver, a processor, and a memory. The wireless receiver is positioned in operative communication with the wireless transmitter of the animal instrumentation assembly and configured to receive the at least one wireless signal from the wireless transmitter. The processor of the computing assembly is configured to convert the at least one wireless signal into at least one corresponding animal data element. The memory of the computing assembly is configured to store the at least one animal data element.

In another aspect, described herein is a method of measuring changes in the motion of the body of an animal. The method can include operatively coupling an animal instrumentation assembly as disclosed herein to the body of the animal. The method can also include using the plurality of motion measurement sensors to produce respective measurement signals indicative of the change in the motion of the animal. The method can further include using the processor to receive the measurement signals from the plurality of motion measurement sensors. The method can also include using the wireless transmitter to selectively transmit at least one wireless signal corresponding to at least one measurement signal produced by the plurality of motion measurement sensors. Additionally, the method can include receiving the at least one wireless signal using a wireless receiver of a computing assembly. The method can further include using the processor of the computing assembly to convert the at least one wireless signal into at least one corresponding animal data element. The method can still further include storing the at least one animal data element in the memory of the computing assembly.

In an additional aspect, described herein is a rodeo flag assembly for selectively transmitting instructions to a rodeo event clock. The rodeo flag assembly has a support element, a flag secured to the support element, at least one motion measurement sensor, a processor, and a wireless transmitter. The support element can be a handle or a rope. The at least one motion measurement sensor can be operatively coupled to the support element, and each motion measurement sensor can be configured to produce a measurement signal indicative of the change in the motion of the support element. The processor can be operatively coupled to the at least one motion measurement sensor, and the processor can be being configured to receive the measurement signal from each respective motion measurement sensor. The wireless transmitter can be operatively coupled to the processor, and the wireless transmitter can be configured to transmit at least one wireless signal to the rodeo event clock upon receipt by the processor of the measurement signal from each motion measurement sensor. Each wireless signal can correspond to a respective measurement signal.

Described herein, in a further aspect, is an automated control system for controlling a rodeo event clock. In this aspect, the automated control system can include a rodeo event clock and a rodeo flag assembly as disclosed herein.

In yet another aspect, described herein is a method of controlling a rodeo event clock. The method can include operatively coupling a rodeo flag assembly as disclosed herein to the rodeo event clock. The method can also include using each motion measurement sensor of the rodeo flag assembly to produce a measurement signal indicative of the change in the motion of the support element of the rodeo flag assembly during a rodeo event. Additionally, the method can include using the processor to receive the measurement signal from each respective motion measurement sensor. The method can further include using the wireless transmitter to transmit at least one wireless signal to the rodeo event clock upon receipt of the measurement signal by the processor. Each wireless signal of the at least one wireless signal can correspond to a respective measurement signal.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

FIG. 1 is a schematic diagram illustrating a conventional method for assigning a bucking intensity or riding difficulty score to a bull or bronco.

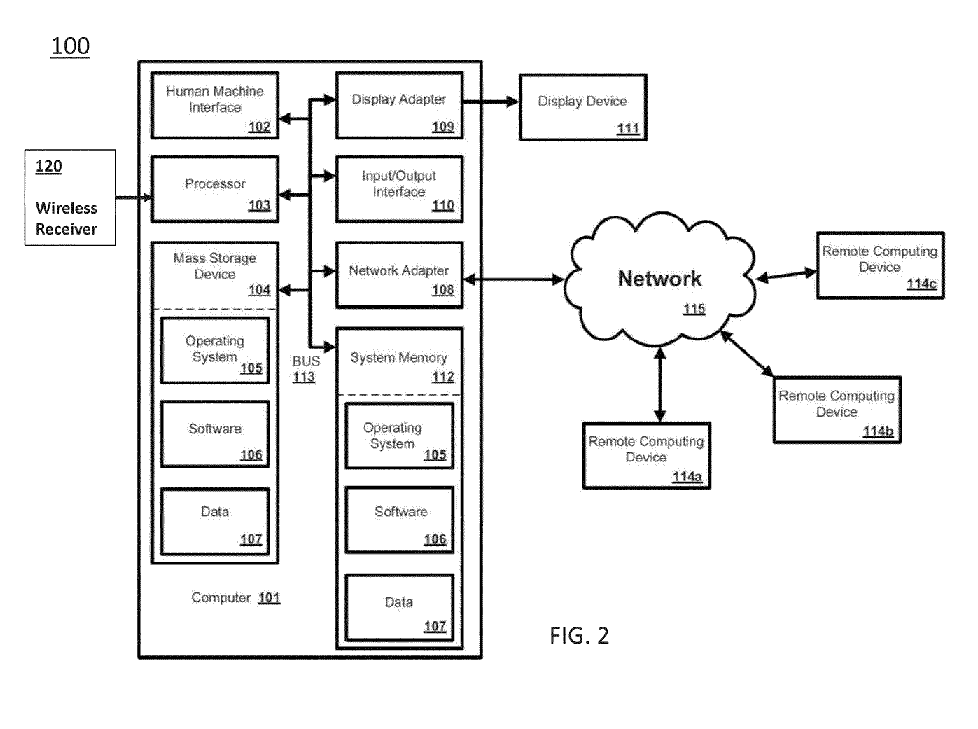

FIG. 2 is a schematic diagram of an exemplary operating environment for a computing assembly as disclosed herein.

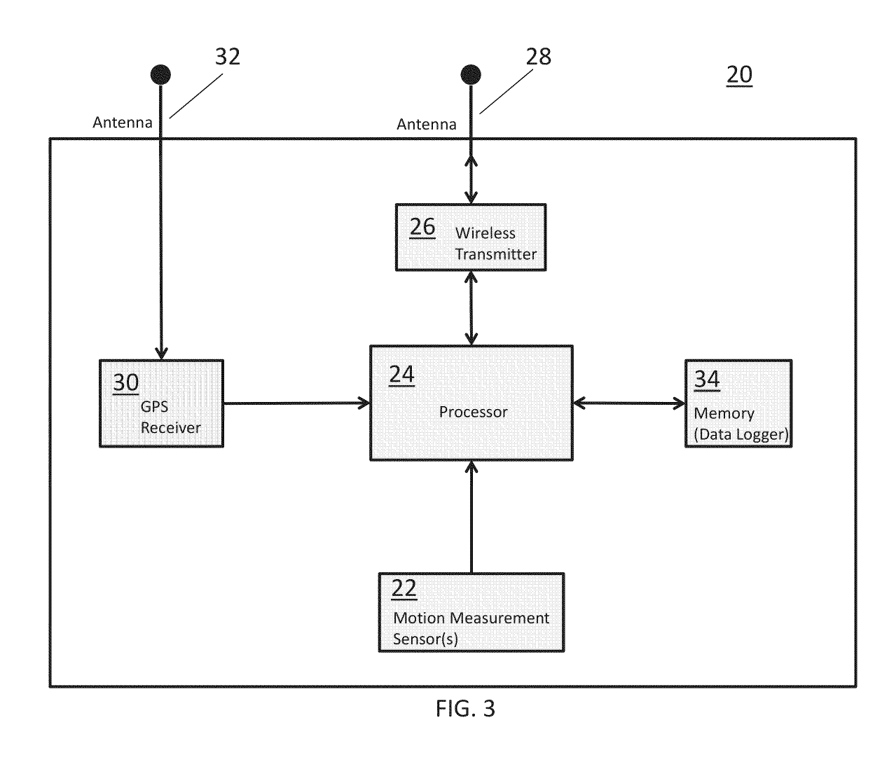

FIG. 3 is a schematic diagram showing an exemplary inertial animal instrumentation assembly as disclosed herein.

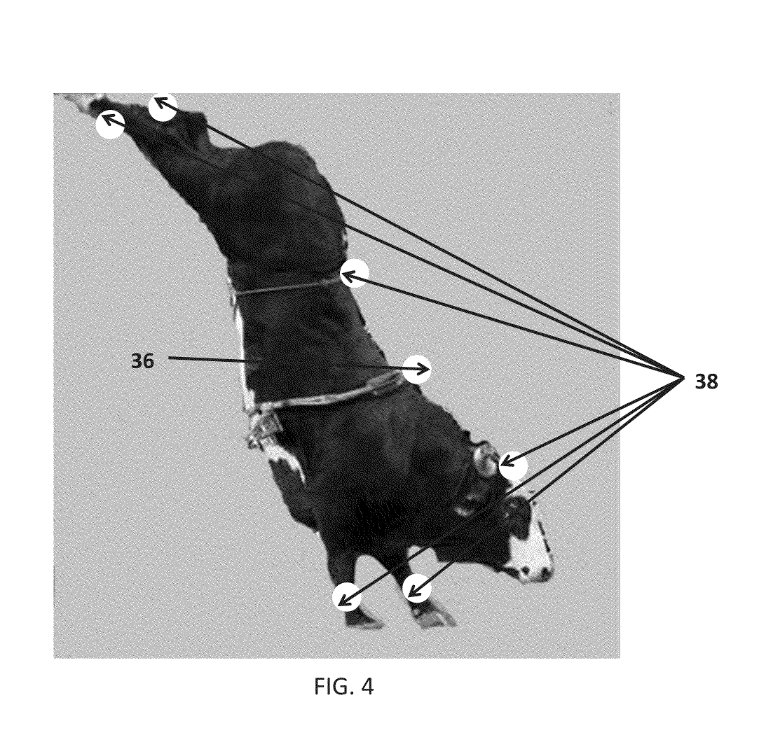

FIG. 4 is a schematic diagram showing exemplary animal instrumentation assembly mounting locations as disclosed herein.

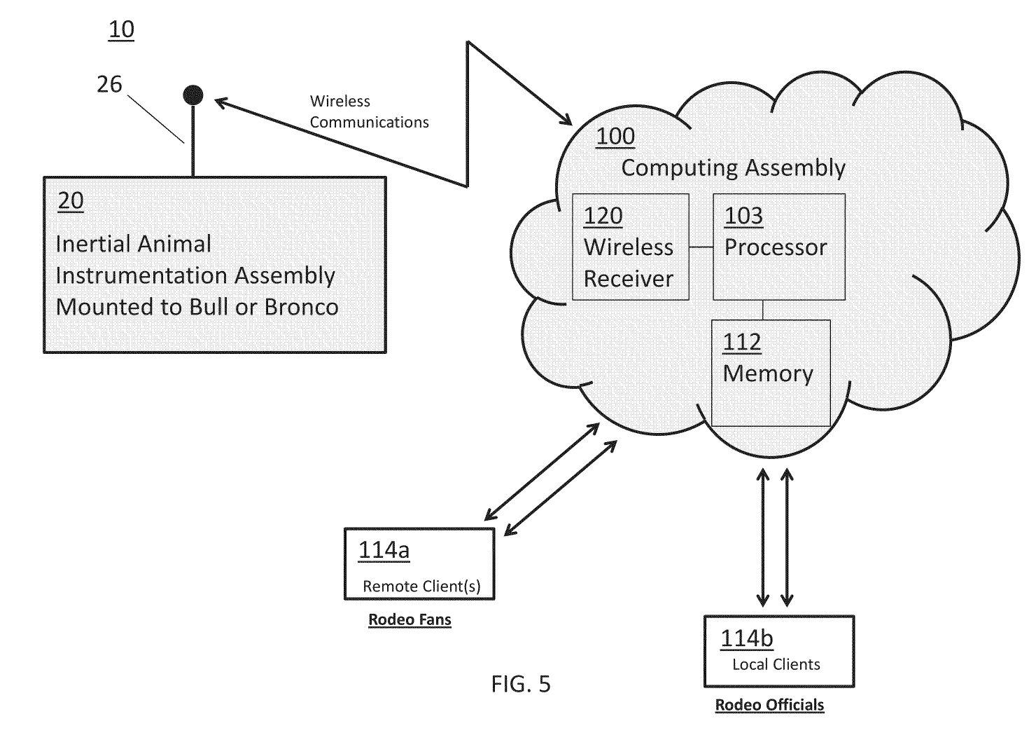

FIG. 5 is a schematic diagram showing an exemplary motion measurement and quantitative scoring system tier a bull or bronco as disclosed herein.

FIG. 6 is a schematic diagram of a conventional method for timing rodeo events as is known in the art.

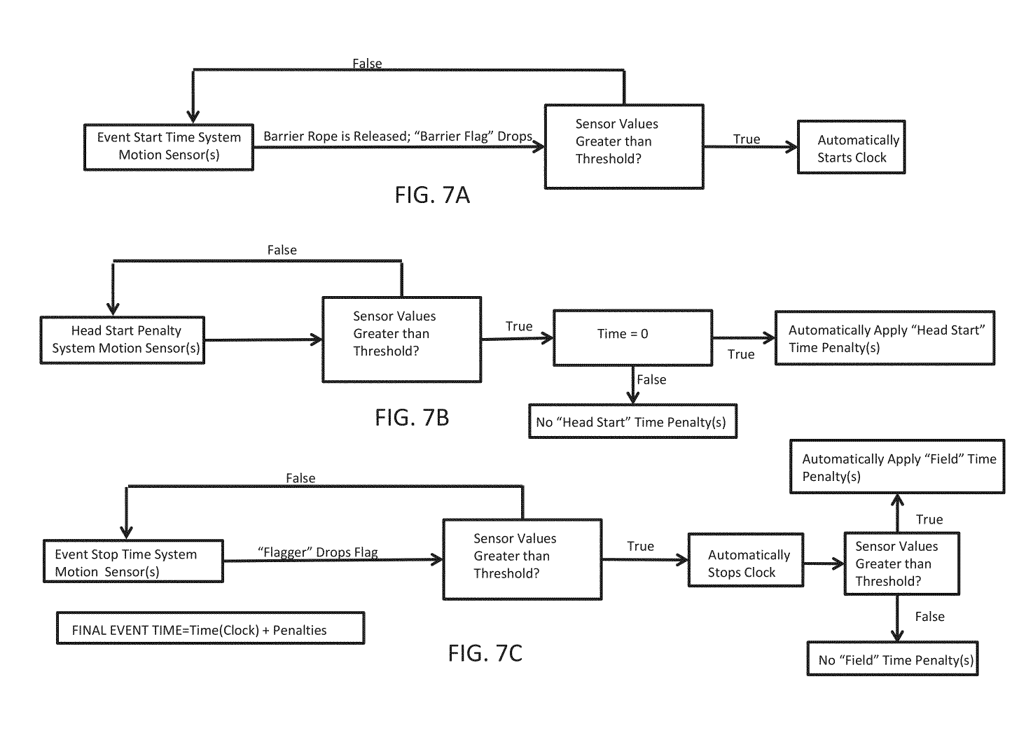

FIGS. 7A-7C are schematic diagrams depicting an exemplary timing method for rodeo events as disclosed herein. FIG. 7A schematically depicts the use of a rodeo flag assembly to start a rodeo event timer as disclosed herein. FIG. 7B schematically depicts the use of a rodeo flag assembly to apply a “head start” penalty to a competitor in a rodeo event as disclosed herein. FIG. 7C schematically depicts the use of a rodeo flag assembly to stop a rodeo event timer as disclosed herein.

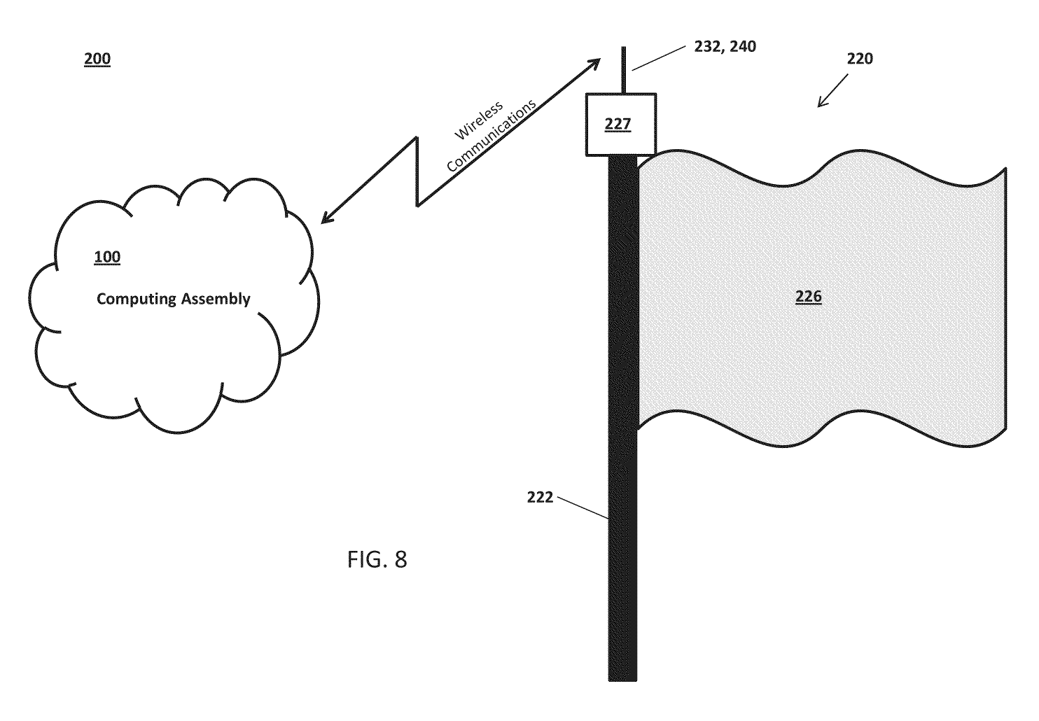

FIG. 8 is a schematic diagram depicting an exemplary “flogger's” rodeo flag as disclosed herein.

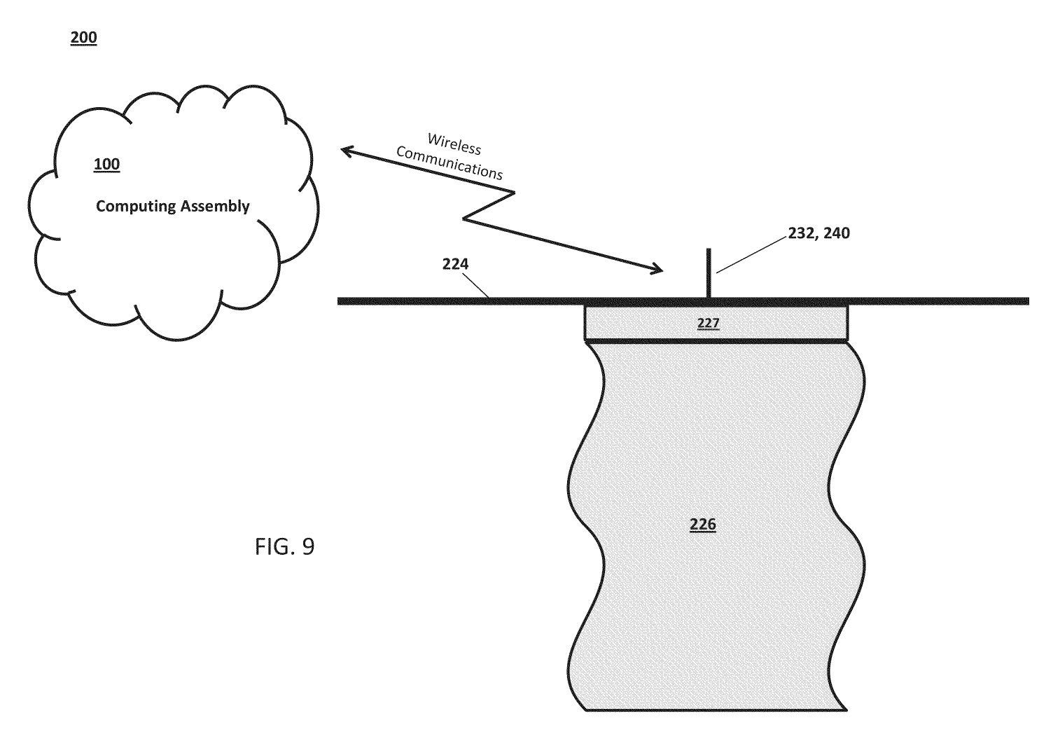

FIG. 9 is a schematic diagram depicting an exemplary “barrier” rodeo flag as disclosed herein.

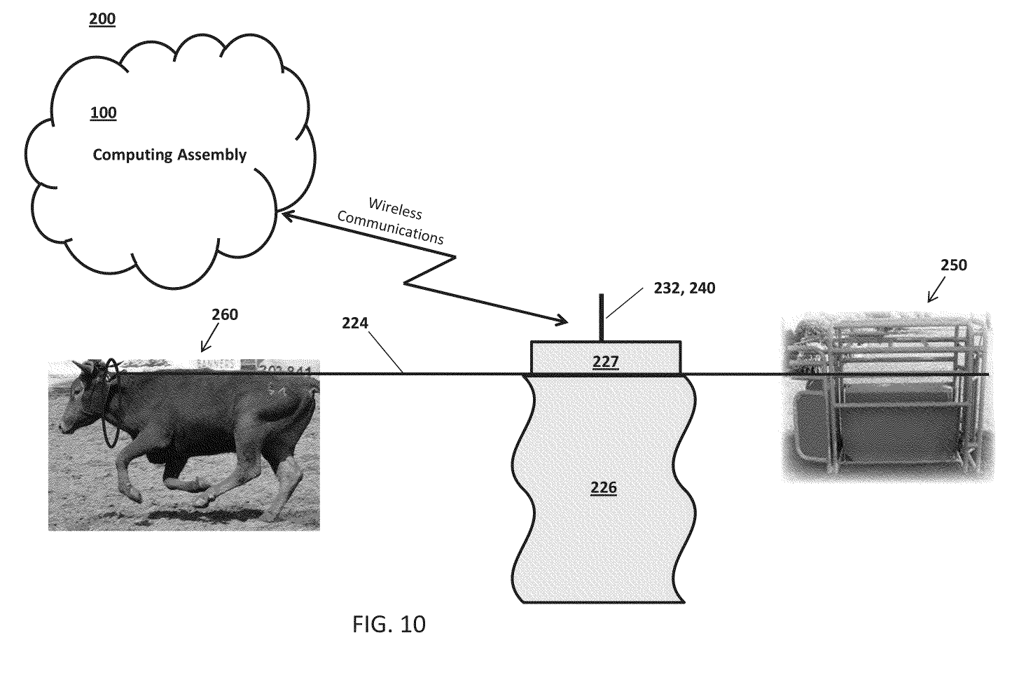

FIG. 10 is a schematic diagram depicting an exemplary “head start penalty” rodeo flag as disclosed herein.

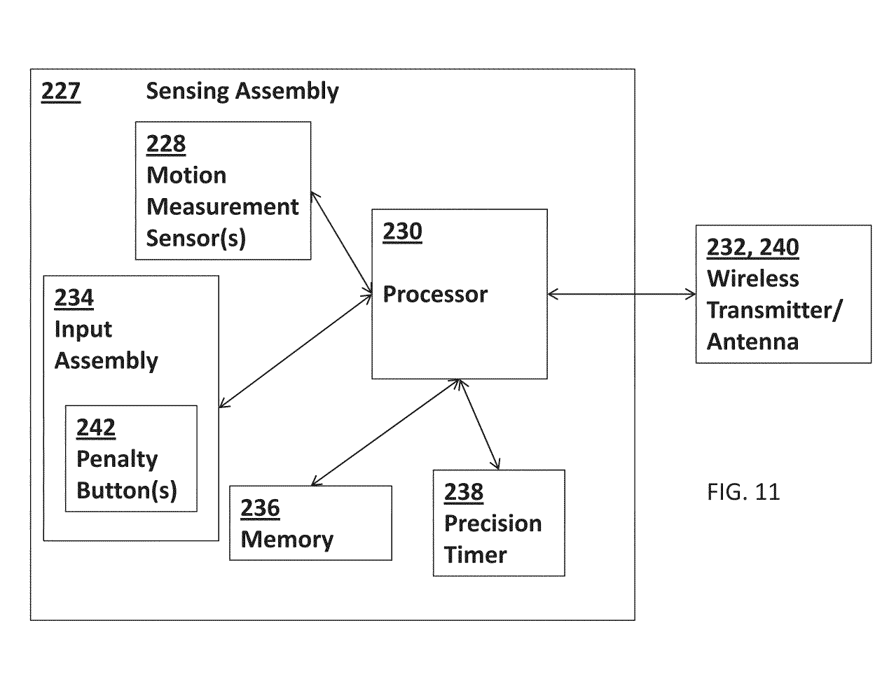

FIG. 11 is a schematic diagram depicting an exemplary sensing assembly as disclosed herein.

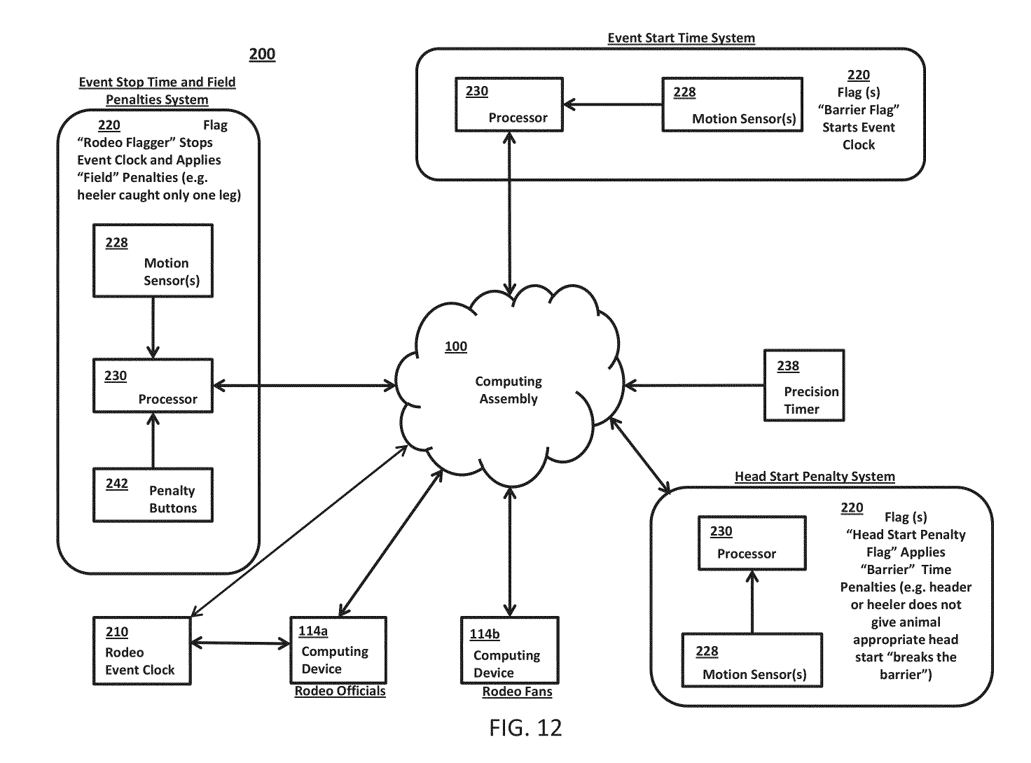

FIG. 12 is a schematic diagram depicting an exemplary rodeo event clock control system having a plurality of rodeo flags as disclosed herein.

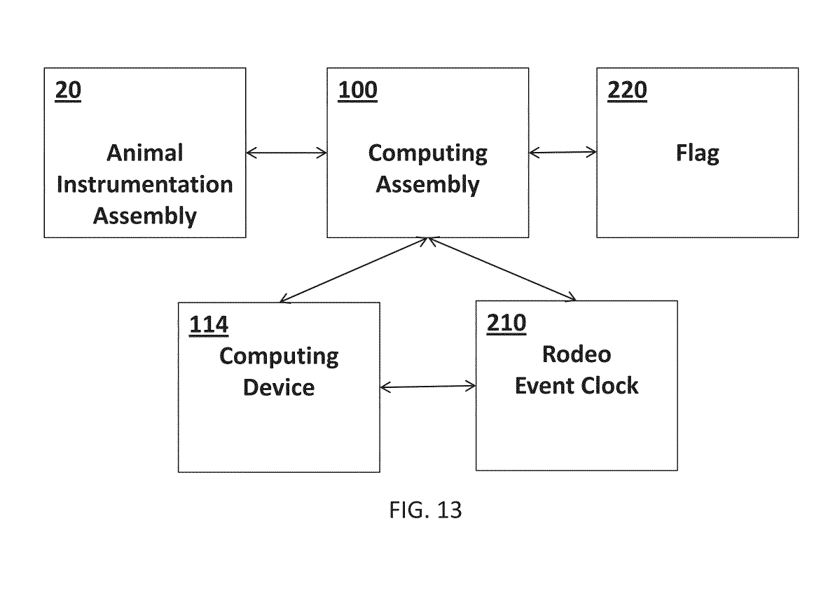

FIG. 13 is a schematic diagram depicting an exemplary integrated system comprising an inertial animal instrumentation assembly and a rodeo flag as disclosed herein.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still Obtaining the beneficial results of the present invention. It will also be apparent that sonic of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a sensor” can include two or more such sensors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

As will be appreciated by one skilled in the art, the disclosed devices, methods, and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Described herein with reference to FIGS. 2-5 and 7A-13 are motion measurement systems and methods for a variety of applications, such as, for example and without limitation, rodeo competitions. In exemplary aspects, and with reference to FIGS. 2-5 and 13, it is contemplated that the motion measurement systems and methods can provide a real-time, quantitative animal rating system for bull riding, bareback bronco riding, and/or saddle bronco riding events. In further exemplary aspects, it is contemplated that the motion measurement systems and methods can provide archived quantitative animal bucking data (e.g., a time-correlated inertial profile). In these aspects, it is contemplated that the archived animal bucking data can be used to configure automated mechanical bull and/or bronco training aids. It is further contemplated that the archived animal bucking data can be used to create accurate dynamic animal animations for video game development, televised bull or bronco riding events, and/or rider training prior to competitive rodeo events. In exemplary aspects, the archived animal bucking data can be used to create accurate dynamic animal animations in at least three dimensions. Optionally, in these aspects, it is contemplated that the archived animal bucking data can be used to create accurate dynamic animal animations in six dimensions (longitudinal, vertical, lateral, pitch, roll, and yaw). It is still further contemplated that the archived animal bucking data can be used by animal breeders and/or livestock companies to evaluate the effectiveness of animal training programs. It is still further contemplated that the archived animal bucking data can be used to assess and/or appraise the value of an animal, such as, for example and without limitation, a bull or a bronco.

In other exemplary aspects, and with reference to FIGS. 2 and 7-13, it is contemplated that the motion measurement systems and methods can provide direct, real-time integration between a rodeo flag assembly and a rodeo event clock. Optionally, in some aspects, the motion measurement systems and methods can permit automatic detection and identification of unique flag movements, with each unique flag movement corresponding to a respective instruction that can be wirelessly and substantially instantaneously transmitted to the rodeo event clock. It is contemplated that this can permit a rodeo flagger to start and/or stop the rodeo event clock and/or apply scoring penalties in real time It is further contemplated that the flag movement data can be stored in a memory. In other optional aspects, it is contemplated that the rodeo flag can be operatively connected with an actuator assembly, such as, for example and without limitation, a button and/or trigger assembly, with each respective actuation of the assembly corresponding to a command that is wirelessly communicated to the rodeo event clock. It is contemplated that the actuation data can be stored in a memory. It is still further contemplated that the motion measurement systems can be operatively connected with a Global Positioning System (GPS system) to precisely assign a time value to the flag movements and/or actuations recorded by the systems.

One skilled in the art will appreciate that provided herein is a functional description and that the respective functions can be performed by software, hardware, or a combination of software and hardware. In an exemplary aspect, the methods and systems can be implemented, at least in part, through a computing assembly 100, which can comprise a computer 101 as illustrated in FIG. 2 and described below. By way of example, the computing assembly and/or rodeo event clock described herein can be a computer as illustrated in FIG. 2. Similarly, the methods and systems disclosed can utilize one or more computers to perform one or more functions in one or more locations. FIG. 2 is a block diagram illustrating an exemplary operating environment for performing at least a portion of the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented through a computing assembly 100, which can comprise a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, control processing software 106, control processing data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as control processing data 107 and/or program modules such as operating system 105 and control processing software 106 that are immediately accessible to and/or are presently operated on by the processing unit 103.

In another aspect, the computer 101 can also comprise other removable/non-removable, volatile/non-volatile computer storage media. By way of example, a mass storage device 104 can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and control processing software 106. Each of the operating system 105 and control processing software 106 (or some combination thereof) can comprise elements of the programming and the control processing software 106. Control processing data 107 can also be stored on the mass storage device 104. Control processing data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like. The display 111 and computer 101 can be part of one device, or separate devices.

The computer 101 can operate in a networked environment using logical connections to one or more remote computing devices 114a,b,c. By way of example, a remote computing device can be a personal computer, portable computer, smartphone, a server, a router, a network computer, a peer device or other common network node, and so on. In exemplary aspects, a remote computing device can be an animal instrumentation assembly and/or a rodeo flag as disclosed herein. In other exemplary aspects, as shown in FIGS. 5 and 12, it is contemplated that rodeo officials (located at the site of a rodeo event) can communicate with the computing assembly 100 via a first remote computing device, while rodeo fans (located at the site of the rodeo event or a location other than the site of the rode event) can communicate with the computing assembly via a second remote computing device. Logical connections between the computer 101 and a remote computing device 114a,b,c can be made via a network 115, such as a local area network (LAN) and/or a general wide area network (WAN). Such network connections can be through a network adapter 108. A network adapter 108 can be implemented in both wired and wireless environments. Such networking environments are conventional and commonplace in dwellings, offices, enterprise-wide computer networks, intranets, and the Internet. It is further contemplated that such networking environments can be used in arenas or other sites of rodeo events and related activities.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of control processing software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The above-described system components may be local to one of the devices (e.g., an animal instrumentation assembly, a computing assembly, or a rodeo flag assembly as disclosed herein) or remote (e.g. servers in a remote data center, or “the cloud”). In exemplary aspects, as shown in FIGS. 5, 8-10, and 12, it is contemplated that many of the system components can be provided in a “cloud” configuration that provides remote, online communication with the computing assembly.

### Animal Motion Measurement Systems

In exemplary aspects, and with reference to FIGS. 3-5, disclosed is a motion measurement system 10 for measuring changes in the motion of the body of an animal, such as, for example and without limitation, a cow (e.g., a bull) or a horse (e.g., a bronco). In these aspects, the motion measurement system can comprise an animal instrumentation assembly 20 and a computing assembly 100. Optionally, the computing assembly 100 can be a computer 101 as disclosed herein. In one aspect, the animal instrumentation assembly 20 of the motion measurement system can comprise a plurality of motion measurement sensors 22. In this aspect, it is contemplated that each motion measurement sensor 22 of the plurality of motion measurement sensors can be configured for operative coupling to a selected portion of the body of the animal. Thus, the animal instrumentation assembly 20 can comprise means for operatively coupling the plurality of motion measurement sensors 22 to the body of the animal. Optionally, in exemplary aspects, the means for operatively coupling the plurality of motion measurement sensors 22 to the body of the animal can comprise a housing that supports the motion measurement sensors in an operative position. In exemplary aspects, the means for operatively coupling the plurality of motion measurement sensors 22 to the body of the animal can comprise hook-and-loop fastener (e.g., VELCRO®) material or other conventional “stick-on” type materials that can be used to operatively secure the housing (or the sensors themselves) to a portion of the body of the animal. In these aspects, it is contemplated that the means for operatively coupling the plurality of motion measurement sensors 22 to the body of the animal can further comprise straps, patches, or other garments and accessories that are provided with surfaces for receiving and engaging the “stick-on” material and that are configured to be worn by or attached to the animal.

Additionally, or alternatively, in some optional aspects, it is contemplated that the means for operatively coupling the plurality of motion measurement sensors 22 to the body of the animal can comprise conventional rodeo accessories or equipment that are positioned in operative contact with the animal during rodeo events. In these aspects, it is contemplated that the rodeo accessories or equipment can comprise at least one of a rider's handle, a flank strap, a bucking strap, a halter, and an ankle strap. For example, in one aspect, it is contemplated that a rider of the animal can be provided with a conventional rider's handle, while a flank strap and/or bucking strap can be positioned on the back of the animal, a halter can be positioned on the head of the animal, and ankle straps can be positioned on the legs of the animal. In this aspect, it is contemplated that a motion measurement sensor 22 can be secured to at least one of the rider's handle, the flank strap, the bucking strap, the halter, and an ankle strap. Optionally, it is contemplated that at least one motion measurement sensor 22 can be secured to each of the rider's handle, the flank strap (or bucking strap), the halter, and the ankle straps. It is contemplated that the at least one motion measurement sensor can be secured to the rider's handle, flank strap (or bucking strap), halter, and ankle straps using respective housings that are mounted to each respective piece of rodeo equipment or, alternatively, by direct mounting to the rodeo equipment. Optionally, it is contemplated that at least one motion measurement sensor 22 can be securely integrated into each respective piece of rodeo equipment.

It is further contemplated that each motion measurement sensor 22 of the plurality of motion measurement sensors can be configured to produce a measurement signal indicative of the change in the motion of the animal. In exemplary aspects, it is contemplated that the plurality of motion measurement sensors 22 can comprise at least one accelerometer. It is further contemplated that the plurality of motion measurement sensors 22 can comprise at least one gyroscope. It is further contemplated that the plurality of motion measurement sensors 22 can comprise at least one magnetometer. It is further contemplated that the plurality of motion measurement sensors 22 can comprise at least one altimeter configured to measure elevation changes. It is further contemplated that the plurality of motion measurement sensors 22 can comprise at least one Global Positioning System (GPS). It is still further contemplated that the plurality of motion measurement sensors 22 can comprise at least one strain gauge. However, it is contemplated that the plurality of motion measurement sensors 22 can comprise any conventional sensor that is capable of providing an output signal indicative of the motion of the body of the animal. In exemplary aspects, in combination, it is contemplated that the plurality of measurement sensors 22 can be configured to measure the change in motion and orientation of the animal with respect to at least three axes. In these aspects, the at least three axes can optionally comprise X-, Y-, and Z-axes, with the X-axis being perpendicular to both the Y- and Z-axes, the Y-axis being perpendicular to both the X- and Z-axes, and the Z-axis being perpendicular to both the X- and Y-axes. Optionally, in exemplary aspects, the plurality of measurement sensors 22 can be configured to measure the change in motion and orientation of the animal with respect to at least six axes. In these aspects, the at least six axes can comprise X, Y-, and Z-axes as described above, as well as pitch, roll, and yaw axes as are known in the art.

In another aspect, and with reference to FIG. 3, the animal instrumentation assembly 20 of the motion measurement system 10 can comprise a processor 24 positioned in operative communication with the plurality of motion measurement sensors 22. In this aspect, it is contemplated that the processor 24 can be configured to receive the measurement signal from each motion measurement sensor 22 of the plurality of motion measurement sensors.

In an additional aspect, and with reference to FIG. 3, the animal instrumentation assembly 20 of the motion measurement system can comprise a wireless transmitter 26 positioned in operative communication with the processor 24 of the animal instrumentation assembly. In this aspect, it is contemplated that the wireless transmitter 26 can be configured to selectively transmit at least one wireless signal corresponding to at least one measurement signal produced by the plurality of motion measurement sensors 22. In exemplary aspects, the wireless transmitter 26 can comprise a wireless data radio as is known in the art. Optionally, in these aspects, the wireless data radio can be positioned in operative communication with an antenna 28 using conventional methods, such as, for example and without limitation, wireless communication methods. It is contemplated that the wireless data radio can be configured to receive data through the antenna 28.

Optionally, in a further aspect, and with reference to FIG. 3, the animal instrumentation assembly 20 can comprise a GPS receiver 30 positioned in operative communication with the processor 24 of the animal instrumentation assembly. In this aspect, it is contemplated that the GPS receiver 30 can be configured to provide precise time information to the processor 24, and the processor can correlate precise time information with each respective measurement signal produced by the plurality of motion measurement sensors 22. It is further contemplated that the GPS receiver 30 can be positioned in operative communication with a GPS satellite through an antenna 32 to receive precise time and/or location information. In exemplary aspects, it is contemplated that each motion measurement sensor 22 of the plurality of motion measurement sensors can be configured to assign a corresponding time value to the measurement signal it produces.

In another optional aspect, and with reference to FIG. 3, the animal instrumentation assembly 20 can comprise a memory 34 positioned in operative communication with the processor 24 of the animal instrumentation assembly. In this aspect, the memory 34 can be configured to store measurement signals and time information associated with an animal during a particular rodeo event. In exemplary aspects, the memory 34 can comprise a data logger as is known in the art.

In one aspect, and with reference to FIGS. 2 and 5, the computing assembly 100 of the motion measurement system can comprise a wireless receiver 120 positioned in operative communication with the wireless transmitter 26 of the animal instrumentation assembly 20. In this aspect, the wireless receiver 120 can be configured to receive the at least one wireless signal from the wireless transmitter 26 of the animal instrumentation assembly 20.

in another aspect, and with reference to FIGS. 2 and 5, the computing assembly 100 of the motion measurement system can comprise a processor 103 positioned in operative communication with the wireless receiver 120. In this aspect, it is contemplated that the processor 103 of the computing assembly 100 can be configured to convert the at least one wireless signal into at least one corresponding animal data element. In an additional aspect, it is contemplated that the processor 103 of the computing assembly 100 can be configured to calculate a score corresponding to the motion of the animal based upon the at least one animal data element.

In a further aspect, and with reference to FIGS. 2 and 5, the computing assembly 100 of the motion measurement system 10 can comprise a memory 112 positioned in operative communication with the processor of the computing assembly. In this aspect, it is contemplated that the memory 112 can be configured to store the at least one animal data element.

In exemplary aspect, as further disclosed herein, it is contemplated that the computing assembly 100 can comprise a user interface 102 positioned in operative communication with the processor 103 of the computing assembly.

In additional exemplary aspects, and as shown in FIG. 5, it is contemplated that the computing assembly 100 can be provided as a “cloud” system as is known in the art. In these aspects, it is contemplated that the cloud system can be provided with time synchronization software and signal processing software to produce the at least one animal data element and score outputs as described herein. It is further contemplated that the cloud system can permit remote access to the memory 112 of the computing assembly 100 for selective retrieval of animal performance information. It is still further contemplated that the cloud system can be configured to automatically transmit animal performance information to a local memory, such as, for example and without limitation, the memory of a computer located at the site of a rodeo event.

In use, the disclosed animal instrumentation assembly can be used in a method of measuring changes in the motion of the body of an animal. In one aspect, the method can comprise operatively coupling the animal instrumentation assembly to the body of the animal. In another aspect, the method can comprise using the plurality of motion measurement sensors to produce respective measurement signals indicative of the change in the motion of the animal. In an additional aspect, the method can comprise using the processor to receive the measurement signals from the plurality of motion measurement sensors. In a further aspect, the method can comprise using the wireless transmitter to selectively transmit at least one wireless signal corresponding to at least one measurement signal produced by the plurality of motion measurement sensors. In yet another aspect, the method can comprise receiving the at least one wireless signal using a wireless receiver of the computing assembly. In a further aspect, the method can comprise using the processor of the computing assembly to convert the at least one wireless signal into at least one corresponding animal data element. In still another aspect, the method can comprise storing the at least one animal data element in the memory of the computing assembly.

As shown in FIG. 4, it is contemplated that at least one motion measurement sensor 22 can be operatively coupled to the back of the animal. In exemplary aspects, it is contemplated that the at least one measurement sensor 22 can comprise at least one motion measurement sensor 22 operatively coupled to a respective leg of the animal, at least one motion measurement sensor operatively coupled to the head of the animal, and at least one motion measurement sensor operatively coupled to the back of the animal. Optionally, as shown in FIG. 4, it is contemplated that the plurality of motion measurement sensors 22 can comprise at least four motion measurement sensors operatively coupled to respective legs of the animal (one motion measurement sensor operatively coupled to each respective leg), at least one motion measurement sensor operatively coupled to the head of the animal, and at least two motion measurement sensors operatively coupled to the back of the animal.

further exemplary aspects, it is contemplated that the processor 103 of the computing assembly 100 of the motion measurement system can assign a score to the motion of the animal during a selected time period, such as, for example and without limitation, a ride of the animal by a rider. In these aspects, it is contemplated that the score assigned by the processor 103 of the computing assembly 100 can correspond to at least one of bucking intensity, riding difficulty, and animal value.

### Rodeo Event Clock Control Systems

FIG. 6 discloses a conventional process for starting a rodeo event clock and applying penalties during a rodeo event. As shown, at the start of a rodeo event, a first start system is used to determine when the rodeo event clock should be started. Typically, a barrier rope with a flag attached is operatively positioned relative to the animal such that upon release, the timekeeper manually starts the rodeo event clock. The timekeeper will not start the rodeo event clock until the barrier rope and flag is released. For certain rodeo events, such as roping events, additional start systems can be employed to determine whether a time penalty should be applied. For example, in team roping events, a time penalty can be applied if one or both members of a team (a “header” or a “heeler”) leave the roping box before a permitted time, such as the time when an animal reaches its designated head start.

In exemplary aspects, and with reference to FIGS. 7A-12, described herein is a rodeo event clock control system 200 that comprises a rodeo event clock 210, a rodeo flag assembly 220 for selectively transmitting instructions to the rodeo event clock, and, optionally, a computing assembly 100 operatively connected to the rodeo event clock and the rodeo flag assembly. In these aspects, the rodeo flag assembly 220 can have a support element and a flag 226 secured to the support element. In one aspect, the support element can be a handle 222. Alternatively, in another aspect, the support element can be a rope 224, such as, for example, a barrier rope as is conventionally known in the art. In additional aspects, the rodeo event clock 210 can comprise a wireless receiver positioned in operative communication with at least one rodeo flag assembly 220 and the computing assembly 100 (where provided).

Optionally, in some aspects, the rodeo flag assembly 220 can comprise at least one motion measurement sensor 228 operatively coupled to the support element (e.g., handle 222 or rope 224). In these aspects, the rodeo flag assembly 220 can comprise a processor 230 operatively coupled to the at least one motion measurement sensor 228 and a wireless transmitter 232 operatively coupled to the processor. In additional aspects, it is contemplated that the rodeo flag assembly 220 can further comprise a memory 236 positioned in operative communication with the processor 230. Optionally, in further aspects, it is contemplated that the rodeo flag assembly 220 can further comprise a precision timer 238 that is positioned in operative communication with the processor 230 and configured to provide the processor with precise time information that can be associated with inputs received by a user and/or measurement signals received from the motion measurement sensors 228. It is contemplated that each motion measurement sensor 228 can be configured to produce a measurement signal indicative of the change in motion of the support element. It is further contemplated that the processor 230 can be configured to receive the measurement signal from each respective motion measurement sensor 228. It is still further contemplated that the wireless transmitter 232 can be configured to transmit a wireless signal to the rodeo event clock 210 upon receipt of the measurement signal by the processor 230, with the wireless signal corresponding to (and being indicative of) the measurement signal. In exemplary aspects, it is contemplated that the at least one motion measurement sensor 228 can comprise at least one accelerometer. In other exemplary aspects, is contemplated that the at least one motion measurement sensor 228 can comprise at least one gyroscope. In still other exemplary aspects, it is contemplated that the at least one motion measurement sensor 228 can comprise at least one strain gauge. In still other exemplary aspects, it is contemplated that the at least one motion measurement sensor 228 can comprise at least one optical detection sensor. In use, it is contemplated that movement of the flag 226 in a predetermined motion can generate a measurement signal corresponding to an instruction to automatically start the rodeo event clock 210, automatically stop the rodeo event clock, and/or automatically apply penalties.

Additionally or alternatively, in other aspects, it is contemplated that the rodeo flag assembly 220 can comprise an input assembly 234 operatively coupled to the support element (e.g., handle 222 or rope 224). In these aspects, the processor 230 of the rodeo flag assembly can be operatively coupled to the input assembly 234. It is contemplated that the rodeo flag assembly 220 can further comprise a wireless transmitter 232 operatively coupled to the processor 230. In additional aspects, it is contemplated that the input assembly 234 can be configured to receive an instruction input from a user. In these aspects, the processor 230 can be configured to receive the instruction input from the input assembly 234. It is further contemplated that the wireless transmitter 232 can be configured to transmit a wireless signal to the rodeo event clock 210 upon receipt of the instruction input from the input assembly 234, with the wireless signal corresponding to (and being indicative of) the instruction input. In exemplary aspects, the input assembly 234 of the rodeo flag assembly 220 can optionally comprise at least one penalty button 242. Optionally, in these aspects, the at least one penalty button can comprise a first penalty button and a second penalty button. In these aspects, it is contemplated that activation of the first penalty button can correspond to an instruction to award no time to and/or disqualify competitors from a particular rodeo event, such as, for example and without limitation, adding event. It is further contemplated that the activation of the second penalty button can correspond to an instruction to apply a time penalty to the competitors of a particular rodeo event, such as, for example and without limitation, a roping event. It is still further contemplated that as long as neither penalty button is activated, a time penalty will not be applied.

In exemplary aspects, and as shown in FIGS. 8-11, the motion measurement sensors 228, the processor 230, the input assembly 234, the memory 236, and the precision timer 238 (where provided) can be provided as a sensing assembly 227. In these aspects, it is contemplated that the sensing assembly 227 can comprise a housing that is configured to support the motion measurement sensors, the processor, the input assembly, the memory, and the precision timer (where provided) in an operative position. It is further contemplated that the housing can be secured to the support element (e.g., handle 222 or rope 224) using conventional means. It is still further contemplated that the housing can be operatively coupled or secured to the support element (e.g., handle 222 or rope 224) such that forces, accelerations, and other changes in the movement of the support element are experienced by, or otherwise transferred to, the sensing assembly 227, and in particular, to the motion measurement sensors 228. In exemplary aspects, the sensing assembly 227 can be integrally formed with an end portion of the handle 222 to maximize transmission of movement/acceleration forces to the sensing assembly. In additional exemplary aspects, the sensing assembly 227 can be integrally formed within a “head start” or barrier rope 224. In further exemplary aspects, the housing of the sensing assembly 227 can comprise means for clipping the sensing assembly to the handle 222 or rope 224. In these aspects, it is contemplated that any conventional clipping mechanism can be used to secure the sensing assembly 227 to the handle 222 or rope 224.

Optionally, in a further aspect, the rodeo flag assembly 220 can comprise a GPS receiver positioned in operative communication with the processor 230 of the rodeo flag assembly. In this aspect, it is contemplated that the GPS receiver can be configured to provide precise time information to the processor 230, and the processor can correlate precise time information with each respective measurement signal and/or instruction input produced by the rodeo flag assembly. It is further contemplated that the GPS receiver can be positioned in operative communication with a GPS satellite to receive precise time information. In exemplary aspects, it is contemplated that the processor 230 can be configured to assign a corresponding time value to each measurement signal and/or instruction input produced by the motion measurement sensors 228 and/or the input assembly 234 of the rodeo flag assembly 220.

In additional exemplary aspects, and as shown in FIGS. 8-10 and 12, it is contemplated that the computing assembly 100, when provided, can be a “cloud” system as is known in the art. In these aspects, it is contemplated that the cloud system can be provided with time synchronization software and signal processing software to produce an instruction output to be wirelessly transmitted to the rodeo event clock 210 after the cloud system receives the wireless signal from the rodeo flag assembly 220. In exemplary aspects, it is contemplated that the cloud system can have a memory 112 that permits storage of the data received from the rodeo flag assembly 220. It is further contemplated that the cloud system can permit remote access to the memory 112 for selective retrieval of the stored data. It is still further contemplated that the cloud system can be configured to automatically transmit data to the rodeo event clock 210.

In use, the disclosed rodeo flag assembly can be used in a method of controlling a rodeo event clock. In one aspect, the method can comprise operatively coupling a rodeo flag assembly to the rodeo event clock. In another aspect, the method can comprise using each motion measurement sensor of the rodeo flag assembly to produce a measurement signal indicative of the change in the motion of the support element during a rodeo event. In an additional aspect, the method can comprise using the processor of the rodeo flag assembly to receive the measurement signal from each respective motion measurement sensor. In a further aspect, the method can comprise using the wireless transmitter of the rodeo flag assembly to transmit at least one wireless signal to the rodeo event clock upon receipt of the measurement signal by the processor. In this aspect, each wireless signal of the at least one wireless signal can correspond to a respective measurement signal. Optionally, when the rodeo flag assembly comprises an input assembly, the method can further comprise using the input assembly to receive an instruction input from a user, using the processor to receive the instruction input from the input assembly, and using the wireless transmitter to transmit a wireless signal to the rodeo event clock upon receipt of the instruction input from the input assembly, the wireless signal corresponding to the instruction input.

In many applications, it is contemplated that a single rodeo flag assembly 220 can be used to transmit instructions to a rodeo event clock 210. In some aspects, as shown in FIG. 7A, when the support element is a barrier rope as shown in FIG. 9, it is contemplated that the processor of the rodeo flag assembly 220 can be configured to initiate timing of a rodeo event when the barrier rope is released and the associated flag is dropped. In these aspects, it is contemplated that the processor can be configured to identify a measurement signal from the at least one motion measurement sensors of the rodeo flag assembly that is indicative of the barrier rope being released and the dropping of the flag. More particularly, it is contemplated that the processor of the rodeo flag assembly 220 can be configured to prevent the rodeo event clock 210 from starting until the processor receives a measurement signal that exceeds a predetermined threshold value.

In other aspects, as shown in FIG. 7B, when the support element is a “head start” rope as shown in FIG. 10, it is contemplated that the processor of the rodeo flag assembly 220 can be configured to apply a time penalty to a rodeo competitor based upon movement of the rope and associated flag prior to activation of the rodeo event clock. In one aspect, the processor can be configured to identify a measurement signal from the at least one motion measurement sensors of the rodeo flag assembly that is indicative of unpermitted movement of the rope and/or flag, such as, for example and without limitation, movement of the rope and/or flag beyond a boundary marker in at least one direction. In this aspect, it is understood that the unpermitted movement is only unpermitted prior to activation of the rodeo event timer; that is, the unpermitted movement can correspond to a head start in a particular rodeo event. In another aspect, the processor can be configured to receive a signal from the rodeo event timer indicating whether the rodeo event timer has been activated. When the processor receives a measurement signal indicative of unpermitted movement of the rope and/or flag, the processor can then determine whether the rodeo event timer has been activated. If the rodeo event timer has not been activated, then the processor can be configured to apply a “head start” time penalty against the rodeo competitor. If the rodeo event timer has already been activated, then the processor can be configured to disregard the unpermitted movement and to not apply a “head start” time penalty against the rodeo competitor.

In further aspects, as shown in FIG. 7C, when the support element is a handle as shown in FIG. 8, it is contemplated that the processor of the rodeo flag assembly 220 can be configured to apply a time penalty to a rodeo competitor based upon movement of the handle by a rodeo “flogger” that identifies unpermitted behavior of a rodeo competitor during a rodeo event (e.g., “heeler” only caught one of the two hind legs). In one aspect, the processor can be configured to identify a measurement signal from the at least one motion measurement sensors of the rodeo flag assembly that is indicative of movement of the handle and/or flag that exceeds a predetermined threshold value, such as, for example and without limitation, a threshold acceleration, a threshold distance, a threshold angular rotation and/or rate, and the like. In another aspect, when the movement by the “flagger” results in a measurement signal that is indicative of movement of the handle and/or flag that exceeds the predetermined threshold value, the processor can be configured to automatically stop the rodeo event clock 210. Additionally, when the movement by the “flagger” results in a measurement signal that is indicative of movement of the handle and/or flag that exceeds the predetermined threshold value, the processor can be configured to apply a “field” time penalty. When the movement of the handle and/or flag by the “flagger” does not results in a measurement signal that is indicative of movement of the handle and/or flag that exceeds the predetermined threshold value, the processor does not apply a “field” time penalty.

As shown in FIG. 12, in some exemplary applications, it is contemplated that a plurality of rodeo flag assemblies 220 can be used, with each rodeo flag assembly providing respective instructions to the rodeo event clock 210. For example, during team roping, calf roping, and steer wrestling events, it is contemplated a plurality of rodeo flag assemblies 220 can be used, with at least one of the rodeo flags being used to effect the starting of the rodeo event clock 210. In at least one rodeo circuit, during these events, a barrier rope is provided in front of the box with a rope around the animal's neck which establishes ahead start for the animal. Once the rope breaks free from the animal, it automatically releases the barrier rope with a flag on it, thereby providing a visual signal to the time keeper to manually start the clock. If the horse breaks through the barrier before the animal to be roped (typically a calf, cow, bull, or steer) reaches its designated head start location (typically measured using a rope around the animal's neck that breaks free), the roper is assigned a time penalty. In exemplary aspects, and with reference to FIG. 12, it is contemplated that a first rodeo flag assembly as disclosed herein can be secured to the barrier rope to permit starting of the rodeo event clock and that a second rodeo flag assembly as disclosed herein can be held by a flagger to permit stopping of the rodeo event clock and assessment of field penalties as further described herein. In these aspects, it is further contemplated that a third rodeo flag assembly as disclosed herein can be secured to a “head start” rope to permit assessment of “head start” penalties as further described herein.

In exemplary aspects, as shown in FIG. 13, it is contemplated that the rodeo flag assemblies 220 as disclosed herein and the animal instrumentation assemblies 20 as disclosed herein can both be operatively coupled to the same computing assembly, which optionally can be a cloud-based system.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A motion measurement system for measuring changes in the motion of the body of an animal, the motion measurement system comprising:
an animal instrumentation assembly comprising:
a plurality of motion measurement sensors, each motion measurement sensor of the plurality of motion measurement sensors being configured for operative coupling to a selected portion of the body of the animal and being further configured to produce a measurement signal indicative of the change in the motion of the animal;
a processor positioned in operative communication with the plurality of motion measurement sensors and configured to receive the measurement signal from each motion measurement sensor of the plurality of motion measurement sensors; and
a wireless transmitter positioned in operative communication with the processor and configured to selectively transmit at least one wireless signal corresponding to at least one measurement signal produced by the plurality of motion measurement sensors; and
a computing assembly comprising:
a wireless receiver positioned in operative communication with the wireless transmitter of the animal instrumentation assembly and configured to receive the at least one wireless signal from the wireless transmitter;
a processor positioned in operative communication with the wireless receiver and configured to convert the at least one wireless signal into at least one corresponding animal data element; and
a memory positioned in operative communication with the processor and configured to store the at least one animal data element.

2. The motion measurement system of claim 1, wherein the plurality of motion measurement sensors comprise at least one accelerometer.

3. The motion measurement system of claim 1, wherein the plurality of motion measurement sensors comprise at least one gyroscope.

4. The motion measurement system of claim 1, wherein the plurality of motion measurement sensors comprise at least one magnetometer.

5. The motion measurement system of claim 1, wherein the plurality of motion measurement sensors comprise at least one altimeter, each altimeter of the at least one altimeter being configured to measure a change in elevation.

6. The motion measurement system of claim 1, wherein the plurality of motion measurement sensors comprise at least one strain gauge.

7. The motion measurement system of claim 1, wherein the animal instrumentation assembly comprises a GPS receiver positioned in operative communication with the processor of the animal instrumentation assembly.

8. The motion measurement system of claim 1, wherein the animal instrumentation assembly comprises a memory positioned in operative communication with the processor of the animal instrumentation assembly.

9. The motion measurement system of claim 1, wherein each motion measurement sensor of the plurality of motion measurement sensors is configured to assign a corresponding time value to the measurement signal it produces.

10. The motion measurement system of claim 1, wherein the plurality of measurement sensors are configured to measure the change in motion and orientation of the animal with respect to at least three axes.

11. The motion measurement system of claim 10, wherein the at least three axes comprises six axes.

12. The motion measurement system of claim 1, wherein the processor of the computing assembly is configured to calculate a score corresponding to the motion of the animal.

13. The motion measurement system of claim 1, wherein the computing assembly comprises a user interface positioned in operative communication with the processor of the computing assembly.

14. A method of measuring changes in the motion of the body of an animal, comprising:
operatively coupling an animal instrumentation assembly to the body of the animal, the animal instrumentation assembly comprising:
a plurality of motion measurement sensors, each motion measurement sensor of the plurality of motion measurement sensors being operatively coupled to a selected portion of the body of the animal;
a processor positioned in operative communication with the plurality of motion measurement sensors; and
a wireless transmitter positioned in operative communication with the processor;
using the plurality of motion measurement sensors to produce respective measurement signals indicative of the change in the motion of the animal;
using the processor to receive the measurement signals from the plural of motion measurement sensors;
using the wireless transmitter to selectively transmit at least one wireless signal corresponding to at least one measurement signal produced by the plurality of motion measurement sensors;
receiving the at least one wireless signal using a wireless receiver of a computing assembly, the computing assembly further comprising:
a processor positioned in operative communication with the wireless receiver; and
a memory positioned in operative communication with the processor;
using the processor of the computing assembly to convert the at least one wireless signal into at least one corresponding animal data element; and
storing the at least one animal data element in the memory of the computing assembly.

15. The method of claim 14, wherein the plurality of motion measurement sensors comprise:
at least one motion measurement sensor operatively coupled to a respective leg of the animal;
at least one motion measurement sensor operatively coupled to the head of the animal; and
at least one motion measurement sensor operatively coupled to the back of the animal.

16. The method of claim 14, wherein the plurality of motion measurement sensors comprise:
at least four motion measurement sensors operatively coupled to respective legs of the animal;
at least one motion measurement sensor operatively coupled to the head of the animal; and
at least two motion measurement sensors operatively coupled to the back of the animal.

17. The method of claim 14, wherein the animal is a bull.

18. The method of claim 14, wherein the animal is a horse.

19. The method of claim 14, wherein the processor of the computing assembly assigns a score to the motion of the animal during a selected time period.

20. The method of claim 19, wherein the selected time period corresponds to a ride of the animal by a rider.

21. The method of claim 20, wherein the score corresponds to at least one of bucking intensity, riding difficulty, and animal value.
